(19) United States
(12) Patent Application Publication
(10) Pub. No.: US 2003/0229785 A1
(43) Pub. Date: Dec. 11, 2003

(54) Dynamic hierarchies system and method for thin devices

(76) Inventors: Michael J. Daseke, Dallas, TX (US); Kirk M. Lampert, Lewisville, TX (US)

Correspondence Address: PILLSBURY WINTHROP LLP, 2550 Hanover Street, Palo Alto, CA, 94304-1115, US

(21) Appl. No.: 10/392,673

(22) Filed: Mar. 18, 2003

Related U.S. Application Data
(60) Provisional application No. 60/365,555, filed on Mar. 18, 2002.
(60) Provisional application No. 60/365,688, filed on Mar. 18, 2002.

(51) Int. Cl. H04L 9/00

(52) U.S. Cl. 713/163

(57) ABSTRACT

A system and method for establishing and monitoring relationships among network devices comprises establishing a device view which has associated therewith at least one group type. The group type provides an umbrella for associating a plurality of groups, with devices assigned to each group. The devices and groups may be dynamically reassigned to permit ease of network administration, and may be established by simple entries in a database.

### FIELD OF THE INVENTION

The present invention relates generally to thin clients and related devices, and more particularly relates to a system and method for establishing hierarchies with a network of thin clients and related devices which permits dynamic reassignment of devices within the hierarchies in response to management criteria.

### BACKGROUND OF THE INVENTION

Thin clients have developed over the last decade as an alternative to networked PCs, to provide better centralized control of security and computing resources than is typically possible with a network of PCs. In addition, thin clients offer greater virus resistance, no moving parts to break down or lose data, reduced service costs, and more standardized connectivity without the rapid obsolescence of PCs.

To achieve these desirable features, a thin client typically maintains the primary computing functions on a server, rather than a local client such as a PC. In one example, the applications programs and data reside on the server and only displays are exchanged between the server and the client.

However, even with the advantages offered by thin clients, network management issues continue to exist. In particular, prior art thin client network management systems use static hierarchies. In a thin client static hierarchy as shown in FIG. 1, each thin client forms a node and a series of nodes is arranged in a fixed tree structure. Queries to the network cannot access clients on other branches of the tree. Thus, for example, an example of a static hierarchy might include a series of nodes arranged according to physical location—New York, Los Angeles, Munich, London and Tokyo. A subsidiary set of nodes for each location might be arranged by department, and thus include Accounting, Finance, and so on. In a conventional static hierarchy, a query which seeks to address all of the Finance thin clients in the entire network would need to include a query to each physical location, so that in our example five separate queries would be required. Conversely, if the network tree is designed along department lines, the tree might be arranged as, for example, Finance, Marketing, Administration, and so on. Then, for each branch relating to a department, a subsidiary branch would be required for each location, again New York, Los Angeles, London, Munich and Tokyo. While this hierarchy would make it straightforward to address all nodes in a particular department, it would be complicated to address all machines in a physical location because a query would have to be addressed to each department. Worse, to change from one form of network hierarchy to the other would require significant time and labor and would require, essentially, dismantling one hierarchy and reconstructing another.

What has therefore been needed is a method and system by which a single query to a thin client network can be addressed to thin clients across a plurality of branches of a network.

### SUMMARY OF THE INVENTION

The present invention overcomes the limitations of the prior art by providing a system and method for permitting queries to extend across branches of a hierarchy, thus providing the possibility of dynamic rearrangement of the nodes within the network based on current administrative needs. Moreover, the present invention permits the efficient hierarchical management of a diverse range of devices, including the traditional thin devices as well as PDAs, bar code scanners, Point of Sale (POS) machines (e.g. cash registers), and cell phones. For convenience, these will be referred to collectively hereinafter as ‘thin devices’.

More particularly, the present invention defines one or more groups, and assigns particular thin device nodes to groups rather than to branches of the network tree. The groups of thin devices may then be reassigned at will to particular network branches, but may continue to be queried across the groups, with the result that queries are not limited to any particular branch of a thin device network. As used hereinafter, “client” will be understood to refer to a thin client, and “device” will be understood to refer to a thin device.

To achieve the goals of the present invention, a “Group” is defined as part of the network infrastructure. The Group is defined in a manner such that the values associated with a Group are not locked to any particular level within the hierarchy. Instead the Group values are associated with a particular device. A View may then be requested where the View define the manner in which one or more Groups of devices are displayed. Multiple methods of organizing device groups can be defined using different views. The default view is All Devices which simply lists all devices without grouping.

### THE FIGURES

FIG. 1 shows a general topology of a thin device network having a single level according to the present invention.

FIG. 2 shows a thin device network having two levels of device view using a dynamic hierarchy in accordance with the present invention, without requiring changes to the hierarchy.

FIGS. 3A-3C illustrate the process of establishing a hierarchy according to the present invention.

FIGS. 4A-4F illustrate various examples of possible configurations of device views.

FIGS. 5A-5B illustrate the dynamic reassignment of devices in accordance with the present invention.

FIGS. 6A-6C illustrate from a user's view the data structures for establishing a new group type.

FIGS. 7A-7C illustrate from a user's view the data structures for establishing a new device view.

FIGS. 8A-8D illustrate from a user's view the data structures for establishing a new group and assigning devices to a group.

### DETAILED DESCRIPTION OF THE INVENTION

The dynamic hierarchical structure of the present invention provide the ability to dynamically change the way thin devices are displayed using different hierarchies. This can be accomplished because values within the hierarchy are not associated with the other levels in the hierarchy. Rather, they are associated with the thin device itself, independent of the other groupings.

General Discussion

To better appreciate the foregoing, the concepts of Views, Device Groups and a Device Manager is helpful. A Device Group is a collection of devices that share the same attributes (e.g., physical location or operating system). All Device Groups have a type called a Group Type which defines common attributes among Device Groups (e.g. City, Department). Views define which Group Type represents each level in the tree hierarchy under the Device Manager, which is the management software program by which the system of the present invention is controlled. Each level in the tree control is of a specific Group Type (e.g. Department) and may contain any number of device groups of that type (e.g. Engineering, Sales, etc.).

In a presently preferred arrangement, multiple methods of organizing device groups can be defined using different views. In an exemplary arrangement, the default view is All Devices which simply lists all devices without grouping.

Group Types define common attributes among device groups, and may be any user-selected criteria such as a functional group (e.g. City, Department), or may be based on a characteristic of the particular thin device, such as processor, OS, media, and so. Such group types based on asset characteristics are built-in, which means that the devices are automatically grouped within these group types based on asset data from the device. Thus, a single device may belong to a plurality of groups, including built-in groups and user defined groups. This arrangement allows multiple different views of the thin device network are shown without the need for reconfiguring the structure of the network or its connection.

Additionally, the user can create user defined views. Views define which Group Type represents each level in the tree hierarchy under the Device Manager, with the overall definition for the particular view being referred to as a tree control. Each level in the tree control is of a specific Group Type (e.g. Department) and may contain any number of Groups of devices of that type (e.g. Engineering, Sales, etc.) with each different device Group having a different Group Value. In addition, each device typically has a Group Value for each Group Type, to allow for the dynamic re-ordering possible with the present invention.

In an exemplary embodiment, the various groups and views are maintained in a database which may, for example, be in the SQL Server. The information in the database can be represented as a series of matrices, an example of which is shown in Tables A through D, below.

TABLE A
Group Type

| # | Description |
|---|---|
| 1 | Location |
| 2 | Department |
| 3 | Operating System |

TABLE B
Group Value

| Group Type # | Value | Value Description |
|---|---|---|
| 1 | 1 | Dallas |
| 1 | 2 | NYC |
| 1 | 3 | LA |
| 2 | 1 | R & D |
| 2 | 2 | Finance |
| 2 | 3 | Marketing |
| 2 | 4 | Legal |
| 3 | 1 | Win |
| 3 | 2 | Linux |
| 3 | 3 | Solaris |

TABLE C
Device Assignment

| Device | Group Type | Group Value |
|---|---|---|
| ID | # | # |
| 1 | 1 | 1 |
| 1 | 2 | 3 |
| 1 | 3 | 1 |
| 2 | 1 | 2 |
| 2 | 2 | 4 |
| 2 | 3 | 2 |
| 3 | 1 | 3 |
| 3 | 2 | 1 |
| 3 | 3 | 3 |
| 4 | 1 | — |
| 4 | 2 | — |
| 4 | 3 | Win |

TABLE D
View

| View Title | Level | Group Type # |
|---|---|---|
| My View | 1 | 1 |
| My View | 2 | 2 |
| His View | 1 | 2 |
| His View | 2 | 1 |
| Her View | 1 | 3 |

Thus in Table A, three types of Groups are illustrated, although the number of types is solely exemplary and could be considerably greater. In the example of Table A, assume that a network manager is establishing dynamic hierarchies for a company that has offices in different cities, but also has clients spread throughout different departments. In addition, assume that the devices can use any of several operating systems. Group Type 1 is defined to be location, while Group Type 2 is defined to be department, and Group Type 3 is the operating system. Note that the operating system is defined by the device itself, and therefore the assignment of that device to a Group Value within Group Type 3 is automatic, or built-in. As will be appreciated hereinafter, each device which has been registered with the system is typically assigned a Group Value for each Group Type, although this may not be necessary in every instance.

Once the group types have been defined, the hypothetical network manager must assign a Group Value to each different possible Group within the Group Type. Thus, in the example of Table B, Group Type 1 [Location] includes three possible locations: Dallas, New York City, or Los Angeles, reflecting three of the company's offices. Thus thee device groups, each having a Group Value, can exist for the first Group Type. Group Type 2 [Department] includes four possible departments or device groups: R&D, Finance, Marketing, and Legal. In addition, Group Type 3 [Operating System] can be any of three groups: Windows, Linux or Solaris.

The network manager must now characterize each of the devices in accordance with each of the Group Types, as shown for three devices in the example of Table C. Thus, assume the first device is located in the Marketing Department in the Dallas office and is running the Windows operating system. As shown in Table C, device 1, for Group Type 1, is assigned a value of 1 because it is in the Dallas office. For Group Type 2, device 1 is assigned a value of 3 because it is in the marketing department. Finally, for Group Type 3, device 1 is assigned a value of 1 because it is running the Windows operating system. Similarly, device 2 is located in the New York City office, in the legal department, and is running Linux, while device 3 is located in the Los Angeles office, in the R&D department, and is running Solaris. Note that the Group Value of the fourth device is unassigned for the first and second group types, but is assigned to the Windows OS group for operating systems. Unassigned devices typically occur because they are newly added to the system, or otherwise have lost their assignment to a user-definable Group Value. However, the operating system is built into the device, and so it automatically is assigned to the Win Group Value of the third Group Type. Once the network administrator assigns the device to its Group Values, the fields take on the assigned values.

Finally, a series of views can be defined, which illustrates the flexibility offered by the dynamic hierarchies of the present invention. In the examples shown in Table D, three different views are illustrated by level, where the description of the View is arbitrary and can be any character string. Thus, “My View” will, on the first, display according to location, or Group Type 1. On the second level, “My View” will display the department for each location. In “His View”, the levels are reversed, and level 1 will display each department while level 2 will display the devices in each location according to department. In “Her View”, on the other hand, only one level is defined, and that displays all devices in the network according to operating system. It will be appreciated that the displays are, in each instance, an illustration of the dynamic nature of the hierarchies possible with the present invention. From Tables A-D, it will also be appreciated that each device has relationships with each group type, but not with a particular view, which allows the views to redefine how each group type is displayed.

Set forth below in pseudocode format, is a simplified exemplary sequence for establishing and changing Group Types, as well as for modifying and creating a View and for creating and modifying a Group Value, and for assigning a device to a Group.

Group Types and Views Psuedo Code

Change Group Types (See Help File for Visual Example)

IF User has permissions THEN

IF Group Type is NOT built-in THEN

Redefine Group Type
Update DB

ELSE

Error Message - Cannot change built-in Group Types

END IF

ELSE

Error Message - Not authorized to change Group Types

END IF
Create Group Types
IF User has permissions THEN

Define Group Type Name and Description
Set Built-In flag to False
Update DB

ELSE

Error Message - Not authorized to create Group Types

END IF
Modify View
IF User has permissions THEN

IF View is Public OR (View is Private AND owned by current user)
THEN

Allow Name Change
Allow specified Group Type Change for View Hierarchy Levels
Update DB

END IF

ELSE

Error Message - Not authorized to change Views

END IF
Create View (See Help File for visual example)
IF User has permissions THEN

Define View Name
Select Group Types for each level of view hierarchy
Update DB

ELSE

Error Message - Not authorized to change Views

END IF
Selecting a View (Dynamic Hierarchy)

Multiple mechanisms exist to set the current view (Dynamic Hierachy). Doing so changes the hierarchy used to display the devices in the device manager. The number of levels in the hierarchy is defined by the levels defined in the view. The Group Type for each level (what the hierarchy's level's groups are based on) is also defined by the selected View.

Building the Hierarchy

IF Current Level < Views Total Number of Levels THEN

Lookup Group Type for Next Level
Get Group Values for Group Types
For Each Group Value

IF Show Empty Folders == False THEN

IF Client Count> 0 THEN

Build Hierarchy Node for Group Value

ENDIF

ELSE

Build Hierarchy Node for Group Value

ENDIF

Next

ELSE

Get Clients for Selected GRoups
Display Client List

END IF

Adding Group Values for a Group Type

To add a new Group Value for a Group Type, select the View Hierarchy level that corresponds to that group type and select the icon or menu option to create a new Group Value. This will add a node to the hierarchy for the selected Group Type. See the Help File for a specific example.

Creating a Group Value

IF User has permissions THEN

Define Group Value

Add Hierarchy Node

Update DB

ELSE

Error Message—Not authorized to add Group Values

END IF

Assigning Devices To Groups

Unassigned devices (not yet belonging to a Group Value) or devices stored in an existing Group Value can be moved to a group by clicking the selected devices displayed in the results pane and dragging them to the desired group. You can also select Cut from the device's right-click menu, and then paste the device(s) from one group to another. Note that you cannot copy devices from one group and paste them into another group. Devices can only belong to one group at a time. Additionally, devices cannot be re-assigned between built-in groups since built-in groups are created from fixed asset data such as operating system type or media size.

Reassigning Group Values for Devices

IF User has permissions THEN

Select Devices to reassign
Select Group Value to assign to
IF Group Type for Group Values is NOT built-in THEN

Update Displayed Device List
Update DB

ELSE

Error Message - Cannot reassign built-in Groups

END IF

ELSE

Error Message - Not authorized to Reassign Group Values

END IF

It will therefore be appreciated that a new and novel method and system for establishing relationships among thin devices located in a network has been described. In particular, the method includes assigning each device a group value for a group type, whereby the device is related to group type but not view. The view can then be dynamically rearranged by the user simply by redefining the levels of the view.

Attached hereto is Appendix A, which is incorporated herein as though set forth in full, and which illustrates in greater detail additional views of the various steps in establishing and managing the dynamic hierarchies of the present invention.

Discussion of Example

As discussed above, Device Views offer a way to visually organize devices functionally for improved ease of management. The present invention uses an organizational system based on group types and groups which allows the user to assign a hierarchical structure to the network's devices. Device Views comprise device hierarchies organized by nested group types and group. As used herein, a “group type” is an umbrella category for organizing groups of devices into Device Views. As an example, the group type ‘Department’ can serve to denote the various departments within an organization (for example, Marketing, Sales, Engineering, etc.). In this example, each individual department is a ‘group’ (sometimes referred to herein as a ‘group instance’) within the larger group type ‘Department’. In one exemplary arrangement of the present invention, a plurality of group types are pre-defined, thus simplifying the organizational process for the user. At the same time, additional, custom group types may be defined, and combinations of pre-defined and custom group types may be used. Examples of pre-defined group types may include, for example, Image (Firmware Image Number), Location, operating system, platform, subnet, vendor ID, or any other paradigm convenient to the application.

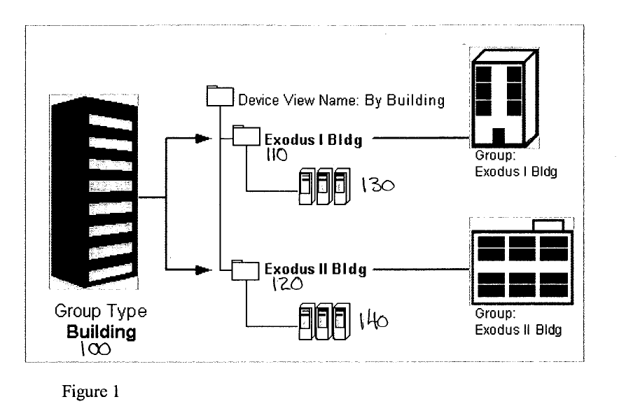

As discussed above, in an exemplary arrangement of the present invention three types of device views are possible: device views that use user-defined group types; device views that use predefined group types, and devices views that combine user-defined and predefined group types. Shown in FIG. 1 is an example of a device view having a single group type, or what may also be thought of as a single level of group type. The group type “building”, designated at 100, includes two group instances, “Exodus I” and “Exodus II”, designated at 110 and 120 respectively, and within each group may occur a plurality of devices, designated generally at 130 and 140, respectively.

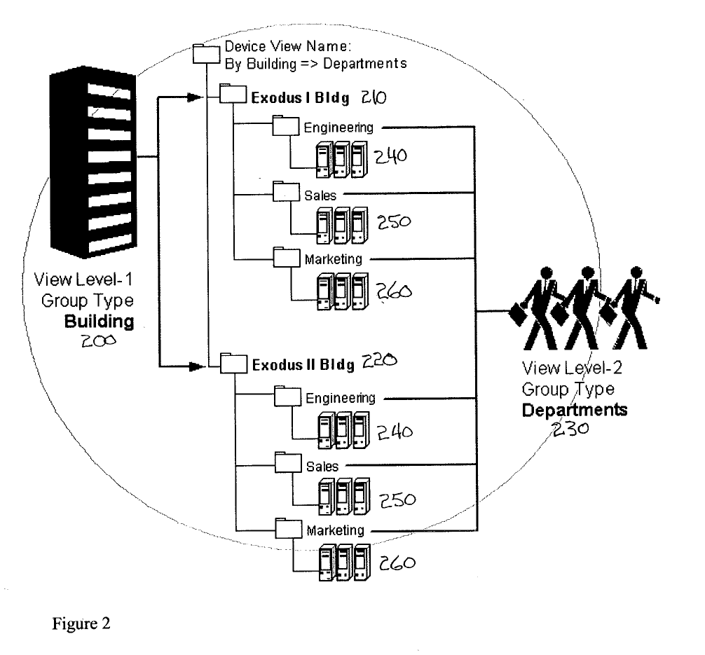

The example of FIG. 1 may be contrasted with that of FIG. 2, in which two levels of group types are defined. In this instance, a first level group type, Building, is designated at 200, with groups ‘Exodus I’ and ‘Exodus II’ as designated at 210 and 220. Then, a second level group type, ‘Departments’ is defined as designated at 230. Within the group type ‘Departments’ are the various groups covered by that umbrella, shown in this example as Engineering, Sales, and Marketing, designated at 240, 250 and 260, respectively. It will be appreciated that, while FIG. 2 shows only two levels of view, an essentially unlimited levels of view are possible.

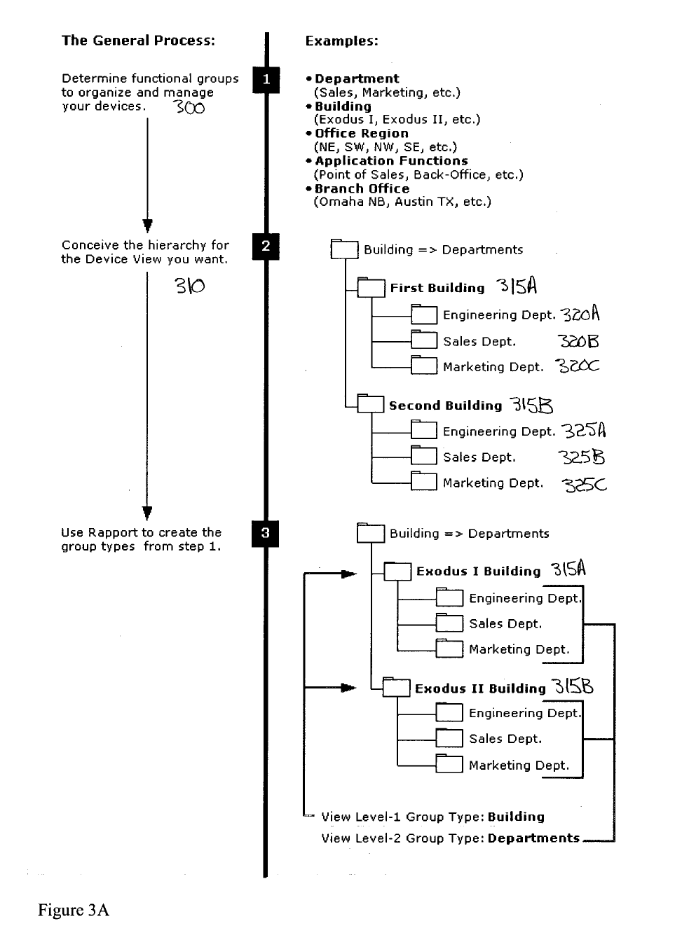

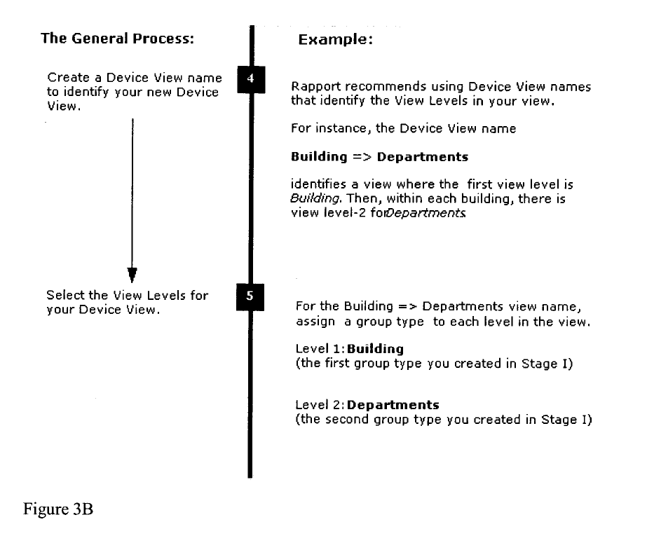

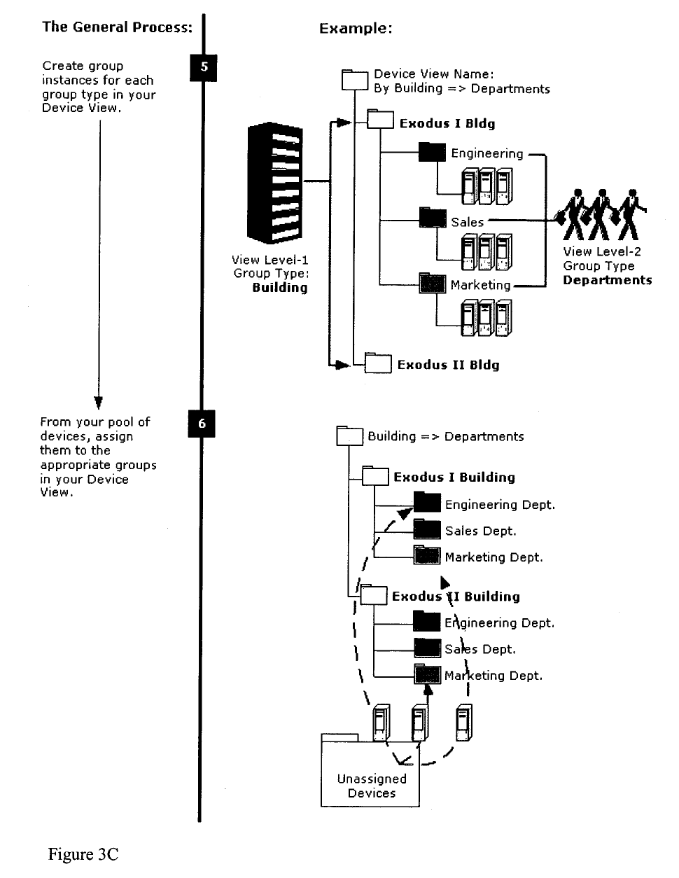

Referring next to FIGS. 3A-3C, the process flow by which Device Views are created can be better appreciated, including the establishment of group types and groups. For convenience, the process step is shown on the left while an example is shown on the right of FIGS. 3A-3C. The first step, shown at 300 in FIG. 3A, is to establish the functional groups, such as Department, Building, Office Region, Function, Branch Office, or any other structural nomenclature the user finds helpful.

After the functional groups are defined, the user determines the hierarchy for the device view, as shown at 310. As just one example, the hierarchy could include group types 200 and 230 of ‘Building’ and ‘Departments’ as discussed in connection with FIG. 2. The groups associated with the ‘Building’ group type then include, for example, first and second buildings as designated at 315A and 315B. At the same time, the departments [Engineering, Sales, Marketing] within each building are established as groups associated with the “Departments” group type, as shown at 320A-C and 325A-C, respectively, and the two views yield the same general result as shown in FIG. 2. In a typical arrangement, the establishment of a Device View is associated with the selection of at least one view level, with the number of view levels establishing the granularity of the hierarchy.

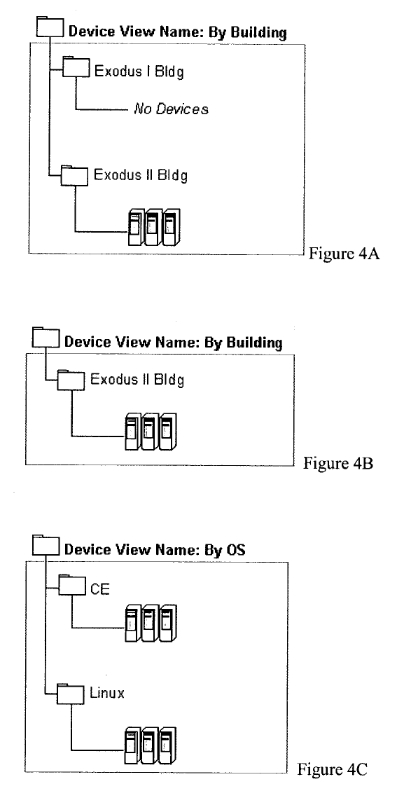

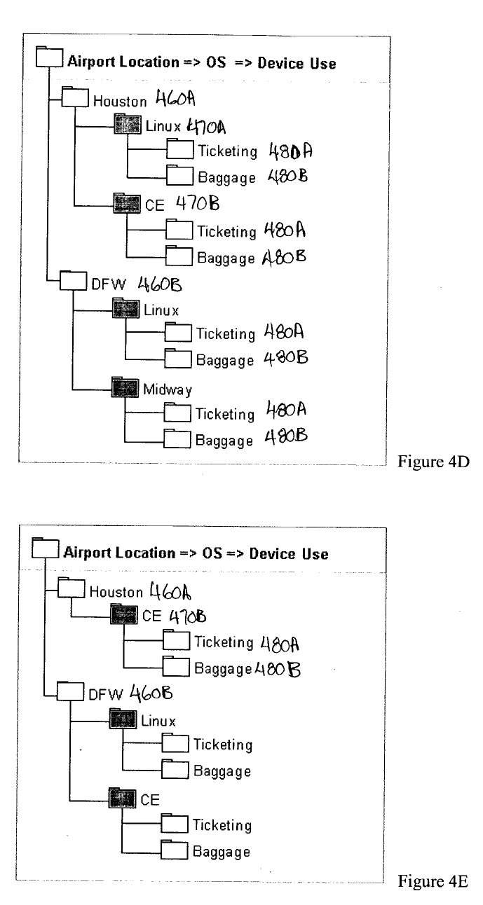

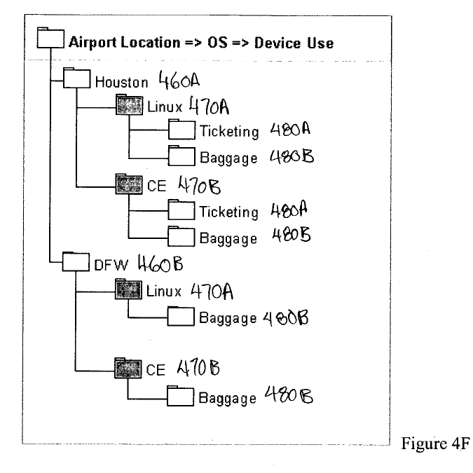

Assignment of devices to a group can also be generally appreciated from FIG. 3C. As shown therein, unassigned devices within a building, or a department, may be assigned to one or more groups. Thus, a device may be viewed in multiple device views. In some instances, a device view can yield no assigned devices. In some instances, it may be desirable to show that no assigned devices exist, while in other instances that may not be desirable. FIGS. 4A-4B show examples of device views and devices viewable within those views, where in FIG. 4A the absence of assigned devices is displayed, whereas in FIG. 4B it is not. In some instances, it may be desirable to limit the display of certain kinds of folders where no assigned devices exist; for example, it may be desirable to hide in the Device View those folders for predefined group types where no assigned devices exist. This can be appreciated from FIG. 4C, where only a device view arranged by operating systems displays only folders for CE and Linux, where assigned devices exist.

Illustrated in FIG. 4D is an arrangement for a device view having predefined and user-defined group types. It will be appreciated that FIG. 4D may represent, for example, an airline with offices 460A-460B in Houston and at DFW, respectively, using both Linux and CE, designated at 470A-470B, with ticketing and baggage functions 480A-B in each place. If, however, Houston has no Linux devices, and it is determined not to show empty folders, the device view of FIG. 4E results. As another example, if DFW should have no ticketing devices of either type, and it is desirable not to configure the device view not to show empty folders, the view of FIG. 4F results.

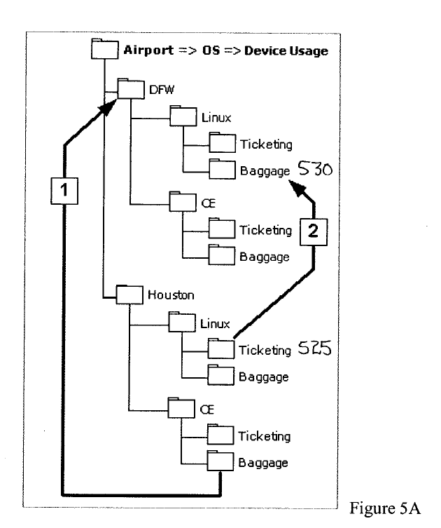

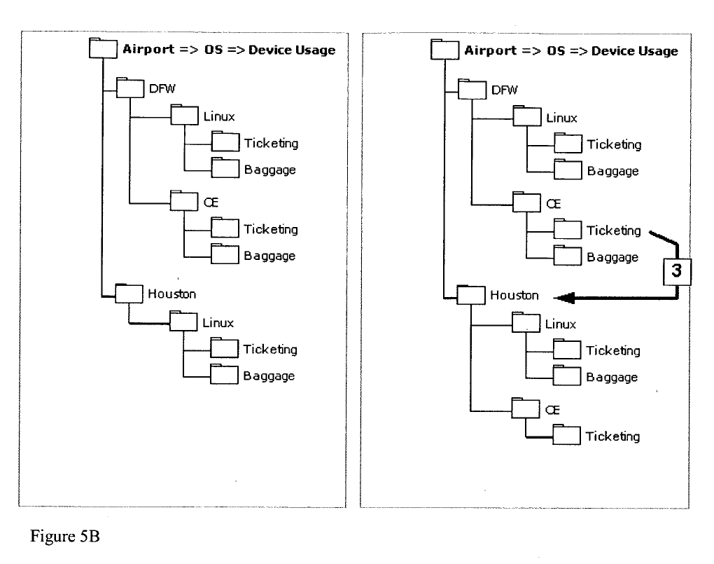

The present invention also permits the movement of devices from one group type to another to be controlled, where movements that are logical can be permitted while those that are not can be prohibited. Thus, for example, as shown in FIG. 5A, a device assigned to the group “ticketing” in Houston shown at 525 may be moved to the group Baggage in DFW shown at 530. Similarly, a device in baggage in Houston may be moved to DFW for its highest level group. Also, as shown in FIG. 5B, it may be desirable to have the associated groups move with a device when the device is moved. Thus, for example, moving a CE device from ticketing in DFW to Houston, where no similar devices already exist, causes the associated folders for those groups to be created in the Houston device view. By contrast, it may be desirable to prevent certain types of moves, such as moving a CE device located in the CE group to a Linux group. Since the CE device cannot respond properly to Linux commands, it would be illogical to permit such a move. Thus, in certain implementations of the present invention, such moves are inhibited.

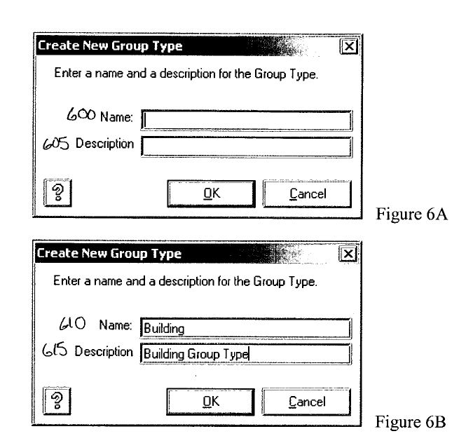

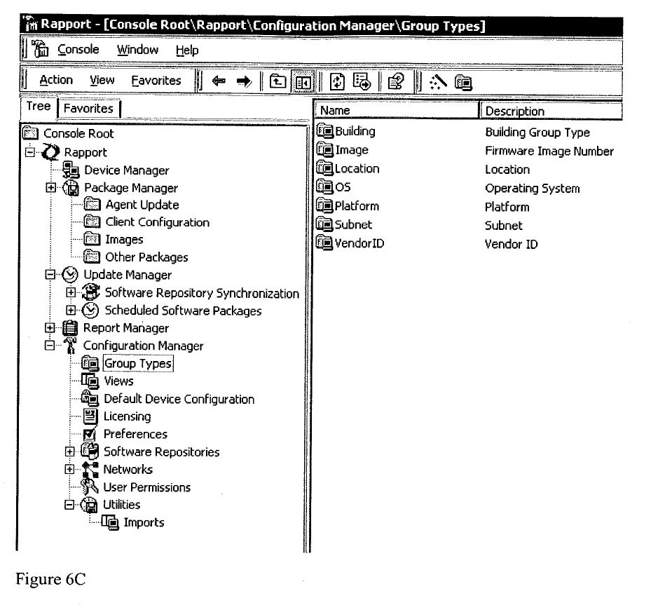

Referring next to FIGS. 6A-6C, the creation of a group type can be better appreciated. The process of establishing a new group type begins by selecting a name, as shown at 600; optionally, a description may also be established as shown at 605. For the example of FIGS. 6A-6C, the group type and description can both be “building”, as shown at 610 and 615 in FIG. 6B. Then, once the group type is selected, the data is added to a database, typically a relationship database, and is then stored and displayed in the pane of the Windows display for Group Types, as shown at in FIG. 6C.

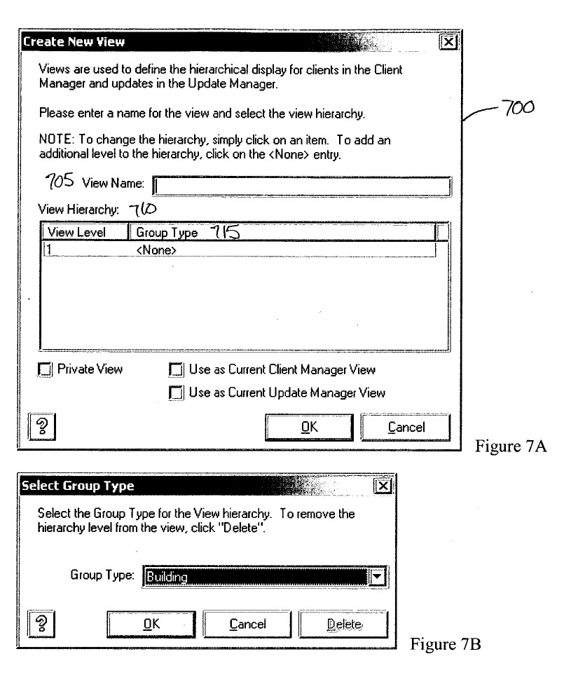

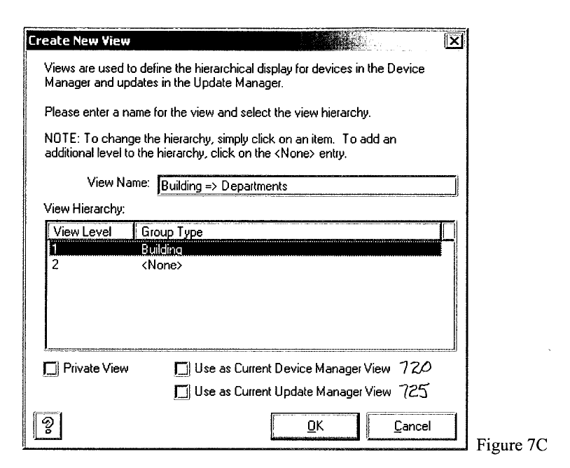

Similarly, a device view can be created by selecting appropriate commands from the configuration manager, such as “New”=>“View”, which brings up a window 700 as shown in FIG. 7A. The new view name can then be entered in a field 705, whereupon the database of views is updated to include the newly added view. A View Hierarchy 710 must then be selected, whereby the level of the new view is established. Then, the Group Type must be selected as shown at 715 in FIG. 7B. The view hierarchy is then updated to show the new view as shown in FIG. 7C. If additional levels are required for the view, the view hierarchy is enlarged by clicking on as many more levels as desired, for example level “2” as shown at 715 in FIG. 7C. The selected view can operate in both the device manager and the update manager, depending on selections made at 720 and 725 in FIG. 7C. The view may also be made private, or secure, by means of a check box 730 which sets a flag in the database.

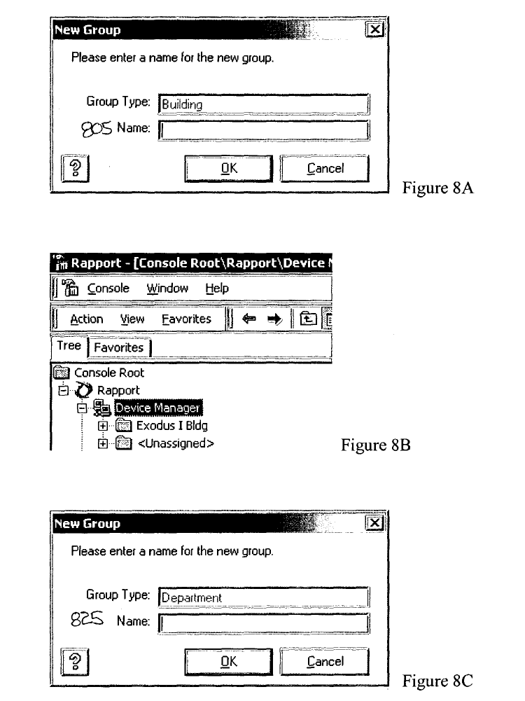

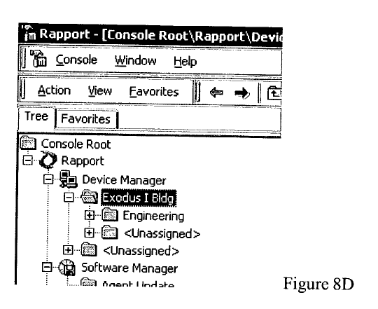

The process by which device groups are created, and devices assigned to such groups, can be better appreciated from FIGS. 8A-8C. Again, the configuration manager serves as a front end to a database. By selecting, for example, “New”=>“Group”, a new group dialog box can be displayed as shown at 800 in FIG. 8A. The group type is already established, and the new group name is then entered in the field 805. This causes the new group name to be displayed in the device manager, as shown in FIG. 8B, which allows devices to be assigned to it. More groups can be created as desired by repeating the foregoing steps. It may also be useful to create groups for additional view levels, as shown at 825 in FIG. 8C, with the results then being displayed in the pane shown at 850 in FIG. 8D.

Then, to assign devices to the various groups, the “unassigned” entry under the Device Manager in FIG. 8D is clicked, causing all unassigned devices to be displayed. The unassigned devices may be dragged and dropped onto the relevant groups, thus updating the configuration database of the present invention.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A method of establishing a configuration hierarchy for devices comprising
providing at least one device,
establishing a group type,
establishing a group,
assigning the at least one device to a group.

2. A system for monitoring devices on a network comprising
a plurality of devices to be monitored,
at least one group type,
at least one device view associated with a group type,
at least one group associated with at least one device and a group type, whereby the device view displays the associated group types, groups and devices.

3. A data structure for monitoring the status of devices on a network comprising
a first entry for a device view,
a second entry for a group type, the group type being related to the device view,
a third entry for a group, the group being related to the group type,
a fourth entry for a device, the device being assigned to a group, whereby a display of the device view displays the related group type, group, and assigned device.
